(19) United States
(12) Patent Application Publication
(10) Pub. No.: US 2025/0161846 A1
(43) Pub. Date: May 22, 2025

(54) Filter for a Fluid Passageway

(71) Applicant: Robert Bosch GmbH, Stuttgart (DE)

(72) Inventor: George Popovici, Woburn, MA (US)

(21) Appl. No.: 18/514,186

(22) Filed: Nov. 20, 2023

(51) Int. Cl. B01D 35/02; B01D 36/04; F28F 19/01

(52) U.S. Cl. CPC B01D 35/02; B01D 36/04; F28F 19/01; B01D 2201/32

(57) ABSTRACT

A fluid delivery system includes a primary fluid passageway and a filter that is configured to receive a portion of fluid that passes through the primary fluid passageway. The filter includes a secondary fluid passageway having a secondary inlet end that intersects the primary fluid passageway and a secondary outlet that intersects the primary fluid passageway at a location downstream of the inlet end. The filter includes a tertiary fluid passageway having a tertiary inlet end and a blind end. The tertiary inlet end intersects the secondary fluid passageway at a third location. The third location is disposed in the secondary fluid passageway between the secondary inlet end and the secondary outlet end, and the blind end disposed at a location spaced apart from the tertiary inlet end.

### BACKGROUND

Cooling systems used in buildings and vehicles may be a complex aggregation of multiple components which are interconnected via fluid passageways. As used herein, the term “components” refers to devices that contact the fluid passing through the cooling system including pumps, valves, filters, heat exchangers, hoses, pipes, bottles, reservoirs, and any cooling channel in a component through which coolant is routed. A cooling system may operate by passing a fluid (e.g., a coolant) through the fluid passageways between the appropriate components.

During the manufacture of the system components, various manufacturing processes may leave behind deleterious contaminants that subsequently contaminate the coolant. Typical contaminants include sand, metal dust and metal chips. The sand may be a remnant of a casting process or may have been used during manufacturing to abrasively remove component material. The metal dust may be a remnant of a grinding process, and the metal chips may be a remnant of a cutting process. Each of these contaminants are solids, generally abrasive, and of density significantly greater than the fluid coolant of, for example, a typical automotive coolant mixture.

Once introduced into the assembled cooling system, such solid contaminants may be carried along with the flowing coolant and may contact all the components in the cooling system. Such contaminants can negatively affect the components due to abrasive wear and clogging of cooling channels. In some cases, these undesirable effects may lead to premature component failure and decreased system efficiency. It is desirable to remove contaminants from the fluid of a cooling system.

### SUMMARY

Referring to FIGS. 1 and 2, the amount of solid contaminant such as particles or other debris carried by the coolant is a function of the local coolant velocity, the size of the contaminant particle, and the density ratio between the fluid coolant and the solid particle. All other things being equal, a faster moving fluid is more able to keep a given particle in suspension than a slower moving fluid. In addition, when the fluid is at zero velocity, all particles that are more dense than the coolant will fall under force of gravity and settle at the lowest surface of the fluid passageway. A filter that is provided in a fluid passageway of an automotive cooling system is configured to take advantage of these settling characteristics of particles suspended in fluid to remove particle contaminants from a fluid coolant. For example, the filter diverts a portion of the fluid flow from a primary fluid passageway into a secondary fluid passageway and directs the diverted flow of the secondary fluid passageway into a network of closed “dead end” chambers where a portion of the diverted fluid will be slowed to essentially zero velocity and, as discussed above, solid particles will settle out of the fluid under force of gravity. For this reason, the filter may be referred to as a “settling filter.” The filter provides a structure where settled particles can be collected and trapped so that they will not re-enter the fluid flow. In addition, the filter returns substantially all of the diverted fluid back to the main flow. In some embodiments, the filter includes a diverter that at least partially defines the secondary fluid passageway and is configured to divert the portion of fluid from the passageway into the network of closed chambers.

In some aspects, a fluid delivery system includes a primary fluid passageway and a filter that is configured to receive a portion of fluid that passes through the primary fluid passageway. The filter includes a filter housing that defines a secondary fluid passageway. The secondary fluid passageway has a secondary inlet end that intersects and fluidly communicates with the primary fluid passageway at a first location of the primary fluid passageway and a secondary outlet end that intersects and fluidly communicates with the primary fluid passageway at a second location of the primary fluid passageway. The second location is downstream of the first location with respect to the direction of fluid flow through the primary fluid passageway. In addition, the filter includes a tertiary fluid passageway. The tertiary fluid passageway has a tertiary inlet end that intersects and fluidly communicates with the secondary fluid passageway at a third location. The third location is disposed in the secondary fluid passageway between the secondary inlet end and the secondary outlet end. The tertiary fluid passageway has a blind end disposed at a location spaced apart from the tertiary inlet end.

In some embodiments, the primary fluid passageway has a first nominal passageway cross-sectional area. The first nominal passageway cross-sectional area is perpendicular to a direction of fluid flow through the primary fluid passageway. The secondary fluid passageway has a second nominal passageway cross-sectional area. The second nominal passageway cross-sectional area is perpendicular to a direction of fluid flow through the secondary fluid passageway, and the second nominal passageway cross-sectional area is less than the first nominal cross-sectional area.

In some embodiments, the second nominal passageway cross-sectional area is in a range of 2 percent to 50 percent of the first nominal cross-sectional area.

In some embodiments, the tertiary fluid passageway is configured so that the blind end is defined by a curved surface.

In some embodiments, the curved surface comprises a plurality of linear surfaces arranged to approximate a curved surface.

In some embodiments, the tertiary fluid passageway has a tertiary nominal passageway cross-sectional area, where the tertiary nominal passageway cross-sectional area is perpendicular to a direction of fluid flow through the tertiary fluid passageway. The tertiary fluid passageway is configured so that the blind end defines a portion of a chamber having curved surfaces that define a terminal chamber. In addition, the terminal chamber has a chamber cross-sectional area that is greater than the tertiary nominal passageway cross-sectional area, where the chamber cross-sectional area is parallel to the tertiary nominal passageway cross-sectional area.

In some embodiments, the secondary fluid passageway has a surface that defines secondary trap openings and each secondary trap opening is configured to allow passage of particles therethrough under force of gravity.

In some embodiments, the tertiary fluid passageway has a surface that defines tertiary trap openings and each tertiary trap opening is configured to allow passage of particles therethrough under force of gravity.

In some embodiments, the secondary fluid passageway and the tertiary fluid passageway each have a surface that defines trap openings. In addition, the trap openings are located within the secondary fluid passageway and tertiary fluid passageway so as to allow passage of particles therethrough under force of gravity.

In some embodiments, each of the secondary fluid passageway and the tertiary fluid passageway define a floor corresponding to the lowermost portion of the fluid passageway with respect to the direction of gravity of the earth, and the floor of the secondary fluid passageway and the floor of the tertiary fluid passageway each have trap openings configured to allow passage of particles therethrough under force of gravity.

In some embodiments, the primary fluid passageway is configured to provide a higher fluid flow velocity at the second location than at the first location.

In some embodiments, the primary fluid passageway is configured to provide a static fluid pressure gradient across the filter when fluid flows through the primary fluid passageway.

In some embodiments, the primary fluid passageway has a first passageway cross-sectional area at the first location and a second passageway cross-sectional area at the second location, and
the first passageway cross-sectional area is less than the second passageway cross-sectional area.

In some embodiments, the primary fluid passageway includes a bend and the filter adjoins an outside radius of the bend.

In some embodiments, the secondary inlet end intersects the primary fluid passageway upstream of the bend with respect to the direction of fluid flow through the primary fluid passageway and the secondary outlet end intersects the primary fluid passageway downstream of the bend with respect to the direction of fluid flow through the primary fluid passageway.

In some embodiments, the secondary inlet end intersects the primary fluid passageway at the bend and the secondary outlet end intersects the primary fluid passageway downstream of the bend with respect to the direction of fluid flow through the primary fluid passageway.

In some embodiments, the filter includes a diverter block that is disposed in the filter housing, the primary fluid passageway is partially defined by a first portion of an inner surface of the housing and a first portion of an outer surface of the diverter block, and the secondary fluid passageway is partially defined by a second portion of the inner surface of the housing and a second portion of the outer surface of the diverter block.

In some embodiments, the first portion of the outer surface of the diverter block and the second portion of the outer surface of the diverter block intersect at an edge. The edge is configured to divert a portion of fluid flow from the primary fluid passageway to the secondary fluid passageway.

In some embodiments, the edge protrudes into the primary fluid passageway.

In some embodiments, the first portion of the outer surface of the diverter block and the second portion of the outer surface of the diverter block the diverter block are vertically extending side surfaces of the diverter block, and the outer surface of the diverter block comprises a third portion that resides in a plane that is perpendicular to the first portion and the second portion.

In some embodiments, the diverter block is configured so that fluid flows along the first portion, the second portion and the third portion, and the third portion comprises a recess that is configured to receive particles therein under force of gravity.

In some embodiments, the tertiary fluid passageway divides into an alpha tertiary fluid passageway and a beta tertiary fluid passageway, and each of the alpha tertiary fluid passageway and the beta tertiary fluid passageway terminates in a blind end.

The filter is advantageous when compared to some conventional in-line porous-medium filters used to capture contamination. For example, the filter does not create a pressure drop since it does not obstruct the way. In addition, the filter does not create an increasing pressure drop as the filter media traps increasing quantities of contamination, as may be the case in the in-line porous medium filters.

### BRIEF DESCRIPTION OF THE FIGURES

FIG. 1 is a graph illustrating the relationship between the ability of a fluid to carry particles versus the fluid velocity.

FIG. 2 is a graph illustrating the relationship between the ability of a fluid to carry particles and the ratio of particle density to fluid density.

FIG. 3 is a schematic illustration of a thermal management system that includes a refrigerant subsystem (shown in broken lines) and a coolant subsystem (shown in solid lines), the coolant subsystem including filter in a primary fluid passageway of the coolant subsystem.

FIG. 4 is a cross-sectional view of the primary fluid passageway and the filter isolated from the coolant subsystem. In this view, the direction of fluid flow through the primary fluid passageway is indicated by the solid arrow.

FIG. 5 is an enlarged perspective view of the portion of FIG. 4 enclosed in broken lines. In this view, the direction of fluid flow through the primary fluid passageway is indicated by the solid arrow.

FIG. 6 is an enlarged top plan view of the portion of FIG. 4 enclosed in broken lines. In this view, the direction of fluid flow through the primary fluid passageway is indicated by the solid arrow, the direction of fluid flow through the secondary fluid passageway is indicated by the broken arrow and the direction of fluid flow through the tertiary fluid passageway is indicated by the dot-dashed arrow.

FIG. 7 is another cross-sectional view of the primary fluid passageway and filter isolated from the coolant subsystem.

FIG. 8 is a schematic illustration of an isolated tertiary fluid passageway formed of smooth, continuously curved surfaces.

FIG. 9 is a schematic illustration of an isolated tertiary fluid passageway formed of a series of linear segments arranged to approximate curved surfaces.

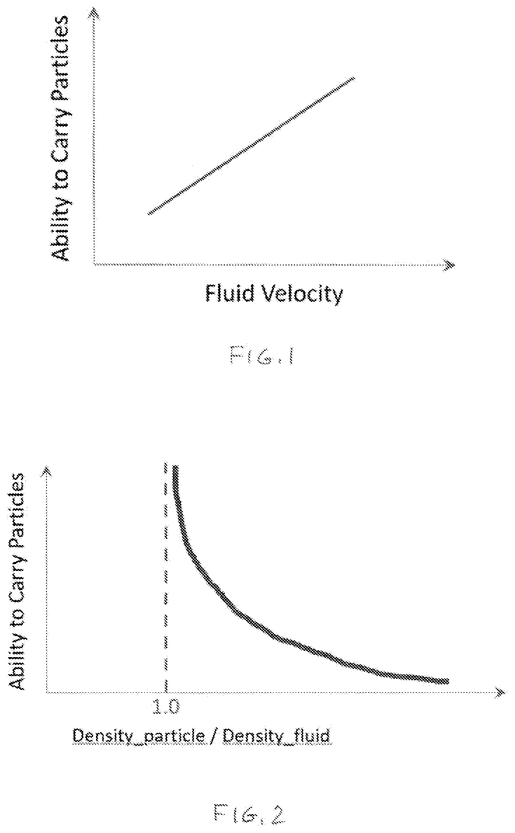

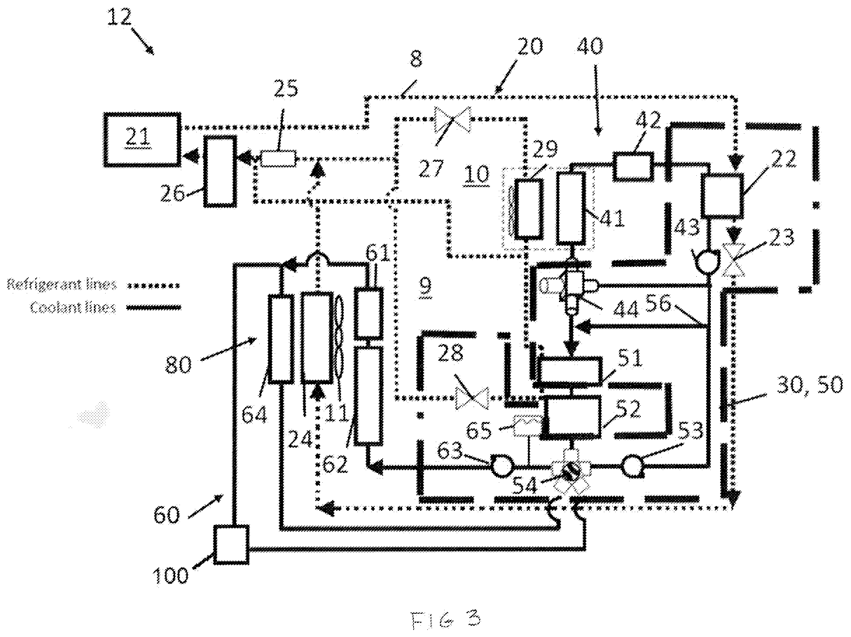

### DETAILED DESCRIPTION

Referring to FIG. 3, a thermal management system 12 for an electric vehicle (not shown) includes a closed-loop refrigerant subsystem 20 and a closed-loop coolant subsystem 30. Each of the refrigerant subsystem 20 and the coolant subsystem 30 include multiple components which are interconnected via fluid passageways 1. The fluid passageways 1 may be arranged into circuits or loops 8, 9, 10, 40, 50, 60 and may be constituted of piping or hoses. Alternatively, the fluid passageways 1 may be channels formed in components or ancillary structures through which fluid is routed. In some embodiments of the thermal management system 12, the fluid passageways 1 may be a combination of piping, hoses and/or channels. In the coolant subsystem 30, cooling of the components is achieved by passing the fluid (e.g., coolant) through the fluid passageways 1 and the components that are connected by the fluid passageways 1. In the coolant subsystem 30, at least one filter 100 is provided in at least one of the fluid passageways 1 for removing particles from the coolant. The filter 100 will be described in detail below.

The electric vehicle may be a battery-electric (i.e., all electric) vehicle (BEV), a plug-in hybrid electric vehicle (PHEV), or a hybrid electric vehicle (HEV). As such, the electric vehicle may include at least one electric traction motor for propulsion of the vehicle. For example, the electric traction motor can be mechanically coupled directly or indirectly to rotate one or more wheels of the vehicle. The electric vehicle may in some constructions include a combustion engine. However, in partial- or full-electric driving modes, drive power requirements from the combustion engine are reduced or eliminated. In other constructions, the electric vehicle has no combustion engine operable for propulsion of the vehicle.

To power the electric traction motor, a traction battery is included in the vehicle. The traction battery may be a high voltage battery (e.g., greater than 100 Volts) and may require cooling or heating under certain circumstances. The traction motor, the wheels and the associated controller and power electronics are referred to herein as the vehicle drivetrain. In addition, a cabin of the vehicle that houses vehicle occupants may be provided with climate control for occupant comfort.

The thermal management system 12 includes a closed-loop refrigerant subsystem 20 and the closed-loop coolant subsystem 30. The refrigerant subsystem 20 provides a vapor-compression refrigeration cycle upon a working fluid, or “refrigerant”. The refrigerant subsystem 20 facilitates thermal management of the vehicle drivetrain via a condenser 22 that provides heat transfer to or from ambient space, and also interfaces with the coolant subsystem 30. The coolant subsystem 30 employs one or more proportional valves 44, 54 to selectively combine vehicle drivetrain thermal management via a vehicle drivetrain coolant loop 60, traction battery thermal management via a battery coolant loop 50 and cabin thermal management (e.g., climate control) via a cabin coolant loop 40. Operation of the thermal management system 12 depends upon vehicle operating conditions, ambient conditions, and climate control requirements of the cabin occupant(s). The refrigerant and coolant subsystems 20, 30 of the thermal management system 12 will now be described in detail.

The refrigerant subsystem 20 includes compressor 21. In some embodiments, the compressor 21 may be an electric compressor. The compressor 21 outputs hot refrigerant to a liquid cooled condenser (LCC) 22, which transfers some heat from the refrigerant to the cabin coolant loop 40. The LCC 22 outputs slightly cooled refrigerant to a first expansion valve 23. The first expansion valve 23 may be an electronic expansion valve (EEV) that can selectively be changed between an expansion mode in which fluid passing therethrough is expanded (cooled) and a fully-open mode in which fluid passing therethrough is unchanged. Unless otherwise indicated, the first EEV 23 is operated in the expansion mode. The first EEV 23 outputs a cold refrigerant, which is directed to a front heat exchanger 24 that is part of an engine cooling fan package 80. The engine cooling fan package 80 includes the front heat exchanger 24, a drive heat exchanger 64 (i.e., a radiator that is part of the drivetrain coolant loop 60) and an engine cooling fan 11 in a stacked arrangement that is typically located immediately behind the front grille (not shown) of a vehicle. The front heat exchanger 24 may transfer heat to the refrigerant, and thus outputs cool refrigerant to the compressor 21 via a shut-off valve (SOV) 25 and an accumulator 26. The compressor 21, the LCC 22, the first EEV 23, the front heat exchanger 24 and the accumulator 26 constitute a main refrigerant loop 8.

The refrigerant subsystem 20 can be controlled to redirect at least some refrigerant to other vehicle components, depending on the configuration of the respective components and the SOV 25. To this end, the refrigerant subsystem 20 includes a first sub-loop 9 in which refrigerant from the front heat exchanger 24 is directed to a second electronic expansion valve 28 prior to passing through the refrigerant side of the battery heat exchanger 51, where it cools the coolant of the battery coolant loop 50 and is then directed to the accumulator 26 and compressor 21, thus returning to the main refrigerant loop 8. In addition, the refrigerant subsystem 20 includes a second sub-loop 10 in which refrigerant from the front heat exchanger 24 is directed to a solenoid thermostatic expansion valve (TXV) 27. Cooled refrigerant exiting from the TXV 27 is directed to an evaporator 29 associated with a cabin heat exchanger 41 of the cabin coolant loop 40. A blower may draw air over both the evaporator 29 and the cabin heat exchanger 41 and into the cabin, bringing hot air in the case of a hot cabin heat exchanger 41 or cool air in the case of a relatively cold evaporator 29. Refrigerant exiting the evaporator 29 is directed to the accumulator 26 and the compressor 21, thus returning to the main refrigerant loop. Depending on the configuration of the respective components, refrigerant may flow through the first sub-loop 9 and not the second sub-loop 10, refrigerant may flow through the second sub-loop 10 and not the first sub-loop 9, or refrigerant may flow through both the first and second sub-loops 9, 10.

The refrigerant used in the refrigerant subsystem 20 is a substance suitable for use in a heat cycle is capable of undergoing a phase change between gas and liquid to allow cooling. For example, in some embodiments, the refrigerant used in the refrigerant subsystem 20 is R1234YF.

The coolant subsystem 30 includes the vehicle drivetrain coolant loop 60, the battery coolant loop 50 and the cabin coolant loop 40 which are selectively combined via proportional valves 44, 54 as required by operating conditions.

The cabin coolant loop 40 includes a first pump 43 that drives coolant fluid through the coolant subsystem 30. Coolant exiting the first pump 43 enters the coolant side of the LCC 22. Heat may be transferred to the coolant within the LCC 22 so that the temperature of the coolant exiting the LCC 22 is greater than the temperature of the coolant exiting the first pump 43. The coolant exiting the LCC 22 is directed to a positive temperature coefficient heater (PTC) 42, where additional heat may be added to the coolant. Thus, the temperature of the coolant exiting the PTC 42 is greater than the temperature of the coolant exiting the LCC 22. The LCC 22 and PTC 42 are in series, which allows for both components to simultaneously contribute heat to the cabin coolant loop 40. The cabin coolant loop 40 includes the cabin heat exchanger 41 that cooperates with the refrigerant cooled evaporator 29 and a blower to effect climate control of the vehicle cabin. For example, due to the relatively high temperature of the coolant flowing through the cabin heat exchanger 41, the temperature within the vehicle cabin may be increased if desired by the vehicle occupants. As discussed previously, refrigerant exiting the evaporator 29 is directed to the accumulator 26 and the compressor 21, thus returning to the main refrigerant loop 8.

Coolant exiting the cabin heat exchanger 41 is directed to a port of a first fluid control valve. In the illustrated embodiment, the first fluid control valve is a four-port coolant proportional valve (CPV) 44, and the coolant exiting the cabin heat exchanger 41 is directed to the first port of the four-port CPV 44. The inlet of the first pump 43 is connected to the second port of the four-port CPV 44, and the third port of the four-port CPV 44 is connected to the battery coolant loop 50, and particularly to an inlet of coolant side of the battery heat exchanger 51.

The battery coolant loop 50 includes the battery heat exchanger 51. The refrigerant side of the battery heat exchanger 51 is part of the first sub-loop of the refrigerant subsystem 20. Coolant exiting the battery heat exchanger 51 is directed to the battery 52, where it is used to cool individual electrochemical cells of the battery 52. Coolant exiting the battery 52 is directed to a port of a second fluid control valve. In the illustrated embodiment, the second fluid control valve is a five-port coolant proportional valve (CPV) 54, and the coolant exiting the battery 52 is directed to the first port of the five-port CPV 54. The battery coolant loop 50 includes a second pump 53, which is connected to a second port of the five-port CPV 54. The second pump 53 drives coolant fluid through the coolant subsystem 30 and is connected to an inlet of the first pump 43. The second pump 53 is also connected to the outlet of the third port of the four-port CPV 44 via a bypass line 56.

The vehicle drivetrain coolant loop 60 includes a third pump 63 that is fed from a reservoir 65. The inlet of the third pump 63 is connected to the fifth port of the five-port CPV 54. The outlet of the third pump 63 is connected to the vehicle power electronics 62, which may include, but is not limited to, a DC-DC converter and an on-board charger (OBC). Coolant exiting the power electronics 62 is directed to an e-axle 61. The e-axle 61 is a compact modular unit that includes the electric traction motor, electronics and the transmission that power the vehicle's axle. Depending on system requirements, the coolant exiting the e-axle 61 may be returned to the fourth port of the 5-port CPV 54 via the drive heat exchanger 64 of the engine cooling fan package 80, or alternatively may be returned to the third port of the 5-port CPV 54 while bypassing the drive heat exchanger 64.

The coolant used in the coolant subsystem 30 is a substance suitable for use in a vehicle cooling system. For example, in some embodiments, the coolant is ethylene glycol or a mixture of ethylene glycol and water.

The components of the coolant subsystem 30 are interconnected via the fluid passageways 1. The fluid passageways 1 used to define the loops 40, 50, 60 of the coolant subsystem 30 are referred to herein as “primary fluid passageways.” The term “primary” as used herein is synonymous with the term “main” and refers to the passageways that extend between and interconnect components of the coolant subsystem 30.

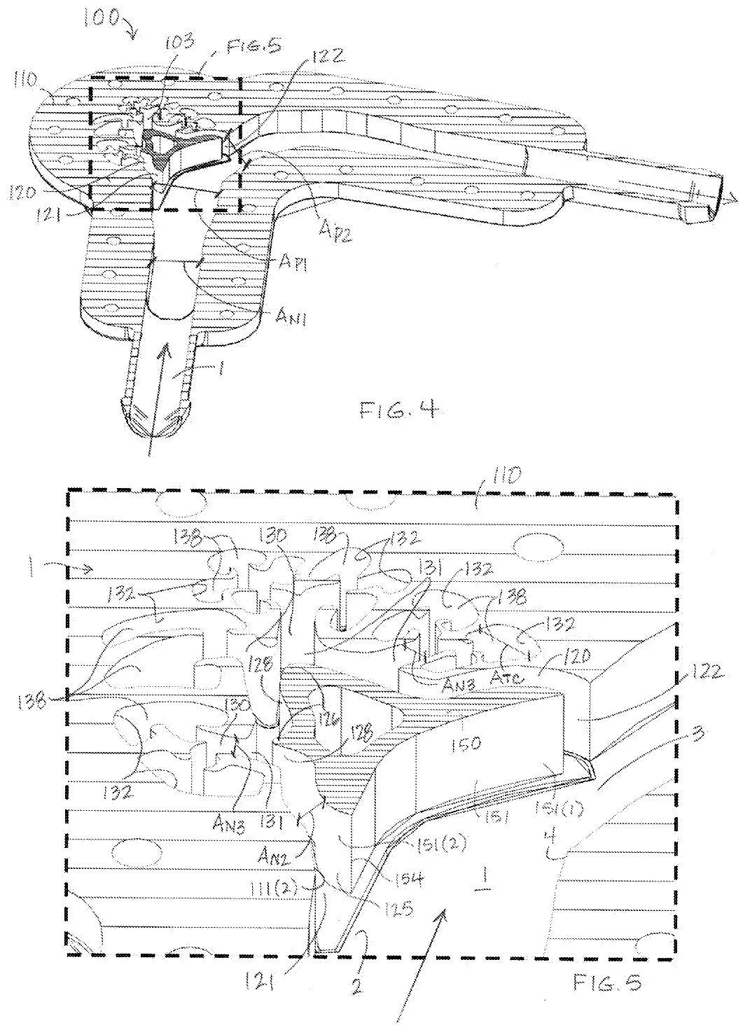

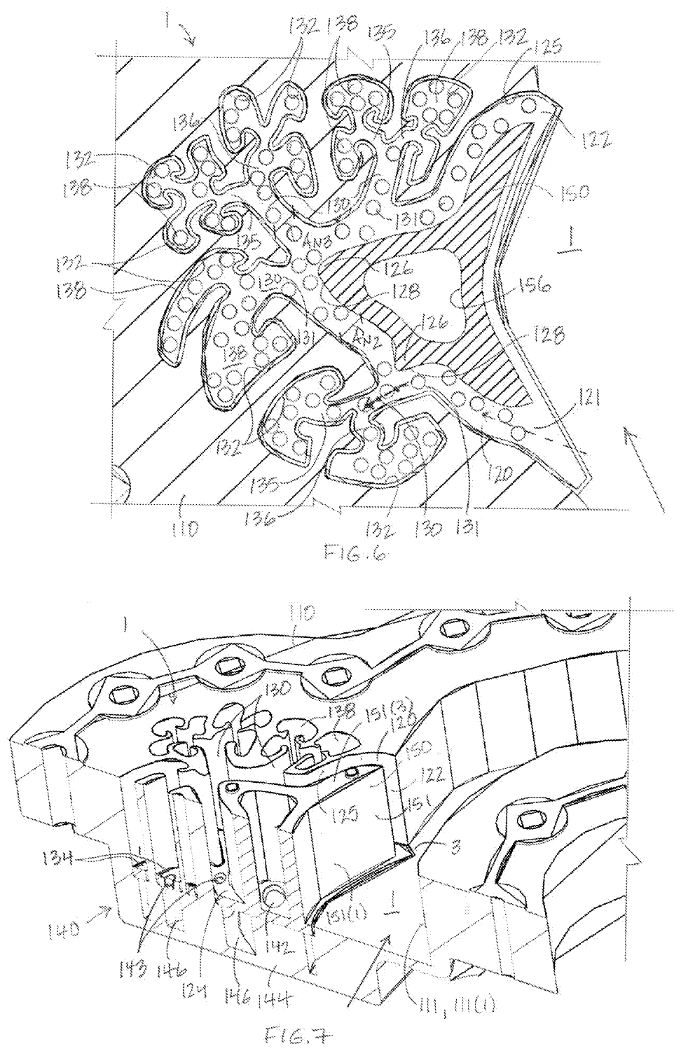

Referring to FIGS. 4-6, the filter 100 is configured to receive a portion of fluid (e.g., coolant) that passes through a primary fluid passageway 1 of the coolant subsystem 30 and to take advantage of settling characteristics of particles suspended in the fluid to remove particle contaminants from the fluid. To this end, the filter 100 includes a filter housing 110, a secondary fluid passageway 120 formed in the filter housing 110 that diverts fluid from the primary fluid passageway 1 and a plurality of tertiary fluid passageways 130 formed in the filter housing 110 that divert fluid from the secondary fluid passageway 120 and form a network of closed, dead-end chambers 138. In addition, the filter 100 includes a particle trap 140 associated with the secondary and tertiary fluid passageways 120, 130 that receives and retains particles that settle within the secondary and tertiary fluid passageways 120, 130.

The secondary fluid passageway 120 branches from the primary fluid passageway 1 and rejoins the primary fluid passageway 1 at a location downstream of the branch point. In particular, the secondary fluid passageway 120 intersects the primary fluid passageway 1 and receives fluid from the primary fluid passageway 1 but does not provide a connection between components of the coolant subsystem 30. In other words, the secondary fluid passageway 120 is contained within the filter 100. In addition, the term “secondary” refers to pertaining to a second order or rank in terms of fluid carrying capacity. For example, in some embodiments, the primary fluid passageway 1 has a first nominal passageway cross-sectional area A_{N1} that is perpendicular to a direction of fluid flow through the primary fluid passageway 1, the secondary fluid passageway 120 has a second nominal passageway cross-sectional area A_{N2} that is perpendicular to a direction of fluid flow through the secondary fluid passageway 120, and the second nominal passageway cross-sectional area A_{N2} is less than the first nominal cross-sectional area A_{N1}. In some embodiments, the second nominal passageway cross-sectional area A_{N2} is in a range of 2 percent to 50 percent of the first nominal cross-sectional area A_{N1}.

The secondary fluid passageway 120 includes a secondary inlet end 121 that intersects and fluidly communicates with the primary fluid passageway 1 at a first location 2 of the primary fluid passageway 1 and a secondary outlet end 122 that intersects and fluidly communicates with the primary fluid passageway 1 at a second location 3 of the primary fluid passageway 1. The second location 3 is downstream of the first location 2 with respect to the direction of fluid flow through the primary fluid passageway 1.

The surfaces of the secondary fluid passageway 120 may be curved, of non-uniform cross-section and may include features that are configured to direct the fluid passing through the secondary fluid passageway 120 into a tertiary fluid passageway 130. For example, the side surfaces 125 of the secondary fluid passageway 120 may be curved in such a way as to promote fluid flow into the tertiary fluid passageways 130. In addition, the side surfaces 125 may include a diverting protrusion 126 at a location opposite to an inlet end 131 of a respective tertiary fluid passageway 130. Although two diverting protrusion 126 are shown, the side surfaces 125 may include a greater or fewer number of diverting protrusions 126, each diverting protrusion 126 being associated with one or more inlet ends 131. The diverting protrusions 126 protrude into the secondary fluid passageway 120 and have a smoothly curved surface 128 that extends toward the inlet end 131 whereby fluid passing through the secondary fluid passageway 120 is directed toward the inlet end 131.

Each tertiary fluid passageway 130 branches from the secondary fluid passageway 120 but does not rejoin the secondary fluid passageway 120 at a location downstream of the branch point. The tertiary fluid passageways 130 depend from the secondary fluid passageway 120 and receive fluid from the secondary fluid passageway 120. Like the secondary fluid passageway 120, the tertiary fluid passageways 130 do not provide a connection between components of the coolant subsystem 30 and are contained within the filter 100. In addition, the term “tertiary” refers to pertaining to a third order or rank in terms of fluid carrying capacity. For example, in some embodiments, each tertiary fluid passageway 130 has a third nominal passageway cross-sectional area A_{N3} that is perpendicular to a direction of fluid flow through the tertiary fluid passageway 130 and that is less than the second nominal cross-sectional area A_{N2}. In some embodiments, the third nominal passageway cross-sectional area A_{N3} is in a range of 2 percent to 95 percent of the second nominal cross-sectional area A_{N2}.

Each tertiary fluid passageway 130 includes a tertiary inlet end 131 that intersects and fluidly communicates with the secondary fluid passageway 120 at a location that is disposed along the secondary fluid passageway 120 between the secondary inlet end 121 and the secondary outlet end 122. Thus, the tertiary fluid passageways 130 intersect the secondary fluid passageway 120 at a location that is downstream of the first location 2 with respect to the direction of fluid flow through the secondary fluid passageway 120.

Each tertiary fluid passageway 130 terminates in a blind end 132 having a concave, smoothly curved surface. The tertiary fluid passageways 130 may be linear or curved and may have a non-uniform cross-section along their length. Thus, the tertiary fluid passageway 130 is free of an outlet and fluid entering the tertiary fluid passageway 130 may slow or stop.

In some embodiments, the tertiary fluid passageways 130 are configured so that the blind ends 132 provide a portion of a chamber having curved surfaces that define a terminal chamber 138. Each terminal chamber 138 has a chamber cross-sectional area A_{TC} that is greater than the tertiary nominal passageway cross-sectional area A_{N3} of the corresponding the tertiary fluid passageway 130, where the chamber cross-sectional area A_{TC} is parallel to the tertiary nominal passageway cross-sectional area A_{N3} (FIG. 5). The terminal chamber 138 is spaced apart from the tertiary inlet end 131 whereby fluid passing through the tertiary fluid passageways 130 moves from a relative narrow passageway into a relatively widened area, further slowing the rate of fluid flow. The solid particles will enter the terminal chambers 138 due to the inertial forces at sudden direction changes of the fluid passageways. In other words, the particles embedded in the flow in secondary passageways 120 may be shot into the tertiary fluid passageways 130 for example due to the friction/viscosity of the almost stagnating fluid therein. The solid particles will lose speed and may fall to the passageway bottom surface 134. The solid particles may end up in the terminal chambers 138 because of two phenomena: turbulence and inertial forces. The area of the final chambers 138 is large not to reduce the speed necessarily, rather to be able to collect and trap solid particles without clogging the holes by providing as many holes on its floor as possible.

At least some of the tertiary fluid passageways 130 are branched to provide a plurality of terminal chambers 138 having blind ends 132. For example, a tertiary fluid passageway 130 may divide into an alpha tertiary fluid passageway 135 and a beta tertiary fluid passageway 136, and each of the alpha tertiary fluid passageway 135 and the beta tertiary fluid passageway 136 terminates in an enlarged terminal chamber 138 having a curved blind end 132. Some of the tertiary fluid passageways 130 may divide into more than two passageways 135, 136.

Referring to FIG. 7, the of the secondary fluid passageway 120 and the tertiary fluid passageways 130 define a bottom surface or floor 124, 134 corresponding to the lowermost portion of the fluid passageway 120, 130 with respect to the direction of gravity of the earth. A particle trap 140 is associated with the floors 124, 134 of the secondary and tertiary fluid passageways 120, 130. The particle trap 140 receives and retains particles that settle under force of gravity within the secondary and tertiary fluid passageways 120, 130 to the floors 124, 134 due to the relatively low fluid flow velocities within the within the secondary and tertiary fluid passageways 120, 130.

The particle trap 140 includes trap openings in the floors 124, 134 that are configured to allow passage of particles therethrough under force of gravity. In particular, the secondary fluid passageway 120 has a floor 124 that defines secondary trap openings 142, and each secondary trap opening 142 is configured to allow passage of particles therethrough under force of gravity. Similarly, the tertiary fluid passageways 130 have a floor 134 that defines tertiary trap openings 143, and each tertiary trap opening 143 is configured to allow passage of particles therethrough under force of gravity. Although the trap openings 142, 143 are illustrated herein as having a circular shape, the trap openings 142, 143 are not limited to this shape. Although the trap openings 142, 143 are illustrated herein as having a uniform size, the trap openings 142, 143 are not limited to having a uniform size. In some embodiments, the trap openings 142, 143 may be formed in the floor 124. 134 for example by drilling or etching. In other embodiments, the floor 124, 134 may be formed by a screen.

The particle trap 140 includes a housing 144 that underlies floors 124, 134 of the secondary and tertiary fluid passageways 120, 130. The secondary and tertiary trap openings 142, 143 provide fluid communication between the respective secondary and tertiary fluid passageways 120 130 and an interior space 146 of the housing 144. When a suspended particle drops from the fluid and settles under force of gravity on the floor 124, 134, it may pass through one of the respective trap openings 142, 143 and into the housing interior space 146. Since the housing interior space 146 is out of the path of fluid flow, the housing 144 provides an enclosure that receives and retains the particles that pass through the trap openings 142, 143.

Referring to FIGS. 4 and 5, In the thermal management system 12, the fluid passageways 1 may include features that enhance the efficiency of the filters 100. For example, in some embodiments, the primary fluid passageway 1 is configured to provide a higher fluid flow velocity at the second location 3 than at the first location 2. As a result, a static fluid pressure gradient is provided across the filter 100 when fluid flows through the primary fluid passageway 1. In this example, the primary fluid passageway 1 has a first passageway cross-sectional area A_{P1} at the first location 2 and a second passageway cross-sectional area A_{P2} at the second location 3, and the first passageway cross-sectional area A_{P1} is less than the second passageway cross-sectional area A_{P2}.

Another exemplary feature of the fluid passageways 1 that enhance the efficiency of the filters 100 includes providing the primary fluid passageway 1 with a bend 4 and positioning the filter 100 so that the filter 100 adjoins an outside radius of the bend 4. In the illustrated embodiment,

The secondary inlet end 121 intersects the primary fluid passageway 1 upstream of the bend 4 with respect to the direction of fluid flow through the primary fluid passageway 1 and the secondary outlet end 122 intersects the primary fluid passageway 1 downstream of the bend 4 with respect to the direction of fluid flow through the primary fluid passageway 1. Alternatively, in other embodiments, the secondary inlet end 121 intersects the primary fluid passageway 1 at the bend 4 and the secondary outlet end 122 intersects the primary fluid passageway 1 downstream of the bend 4 with respect to the direction of fluid flow through the primary fluid passageway 1.

In the filter 100, the network of dead-end cells defined by the tertiary fluid passageways 130 including the terminal chambers 138 having blind ends 132 bring the velocity of the fluid flow within the passageway 130 to substantially zero. As a result, the particles in the fluid settle to the respective floor 124, 134. Many settled particles may pass through the trap openings 142, 143 and become trapped in the housing 144. Thus, the filter 100 serves to remove particle contaminants from a fluid coolant within a coolant subsystem 30.

In some embodiments, the material of the filter housing 110 that separates the secondary fluid passageway 120 from the primary fluid passageway 1 may define a diverter block 150. Thus, the primary fluid passageway 1 is partially defined by a first portion 111(1) of an inner surface 111 of the filter housing 110 and a first portion 151(1) of an outer surface 151 of the diverter block 150. The secondary fluid passageway 120 is partially defined by a second portion 111(2) of the inner surface 111 of the filter housing 110 and a second portion 151(2) of the outer surface 151 of the diverter block 150. The first and second portions 151(1), 151(2) of the outer surface 151 of the diverter block 150 are vertically extending side surfaces of the diverter block 150 (e.g., they extend in a direction generally perpendicular to the floor 124).

The first and second portions 151(1), 151(2) of the diverter block outer surface 151 intersect at an edge 154, and the edge 154 is configured to divert a portion of fluid flow from the primary fluid passageway 1 to the secondary fluid passageway 120. In some embodiments, the edge 154 faces into the fluid flow within the primary fluid passageway 1. In some embodiments, the edge 154 may protrude into the primary fluid passageway 1.

In addition, the diverter block 150 also includes a top surface, corresponding to a third portion 151(3) of the outer surface 151 that resides in a plane that is generally perpendicular to the first and second portions 151(1), 151(2). The diverter block 150 is configured so that fluid may flow along the first portion 151(1) (e.g., through the primary fluid passageway 1), along the second portion 151(2) (e.g., through the secondary fluid passageway 102) and along the third portion 151(3) (e.g., over the top surface of the diverter block 150). In some embodiments, the third portion 151(3) or top surface includes a recess 156 that serves to receive and retain particles suspended in the fluid.

The efficiency of the filter 100 is optimized when the filter 100 is located in a portion of the fluid-flow system that is substantially horizontal so that gravity forces can drive the settled particles into the particle trap 140 and retain the particles therein. Although the filter 100 may be placed at locations where the primary fluid passageway is inclined as much as 30 degrees to 40 degrees, the efficiency of the filter 100 may be lower than compared to a horizontal or substantially horizontal location.

Although the filter has been described herein as being used in a cooling system of an electric vehicle, the filter may be used in any cooling system, and is not limited to being used in any type of vehicle. In particular, the filter may be used in the cooling system of an electric vehicle, a hybrid vehicle or a vehicle powered by an internal combustion engine.

The filter is not limited to being used in the cooling system of a vehicle and can be used in other applications such as the cooling systems of buildings or devices. Moreover, the filter is not limited to being used in a cooling system and may be employed in any fluid system.

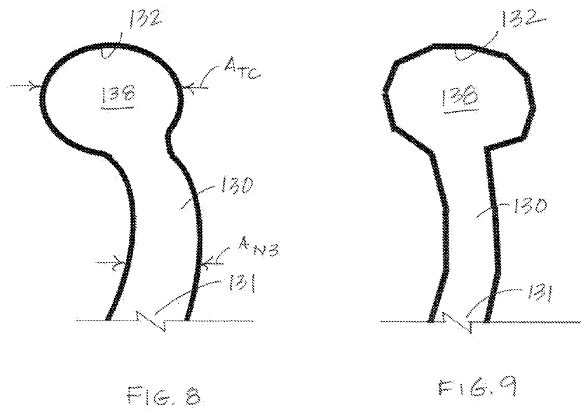

Although the blind end 132 is illustrated herein as having a continuously smooth and continuously curved surface (FIGS. 5-8), it is not limited to this configuration. For example, in some embodiments, the curved surface may comprise a plurality of linear surfaces arranged to approximate a curved surface (FIG. 9).

Selective illustrative embodiments of the cooling system including the fluid filter are described above in some detail. Only structures considered necessary for clarifying the cooling system and the fluid filter have been described herein. Other conventional structures, and those of ancillary and auxiliary components of the cooling system and the fluid filter are assumed to be known and understood by those skilled in the art. Moreover, while a working example of the cooling system and the fluid filter have been described above, the cooling system and the fluid filter are not limited to the working example described above, but various design alterations may be carried out without departing from the cooling system and the fluid filter as set forth in the claims.

We claim:

1. A fluid delivery system, comprising:
a primary fluid passageway; and
a filter that is configured to receive a portion of fluid that passes through the primary fluid passageway, the filter including a filter housing that defines
a secondary fluid passageway, the secondary fluid passageway having
a secondary inlet end that intersects and fluidly communicates with the primary fluid passageway at a first location of the primary fluid passageway, and
a secondary outlet end that intersects and fluidly communicates with the primary fluid passageway at a second location of the primary fluid passageway, the second location being downstream of the first location with respect to the direction of fluid flow through the primary fluid passageway, and
a tertiary fluid passageway, the tertiary fluid passageway having
a tertiary inlet end that intersects and fluidly communicates with the secondary fluid passageway at a third location, the third location being disposed in the secondary fluid passageway between the secondary inlet end and the secondary outlet end, and
a blind end disposed at a location spaced apart from the tertiary inlet end.

2. The fluid delivery system of claim 1, wherein
the primary fluid passageway has a first nominal passageway cross-sectional area, the first nominal passageway cross-sectional area being perpendicular to a direction of fluid flow through the primary fluid passageway,
the secondary fluid passageway has a second nominal passageway cross-sectional area, the second nominal passageway cross-sectional area being perpendicular to a direction of fluid flow through the secondary fluid passageway, and
the second nominal passageway cross-sectional area is less than the first nominal cross-sectional area.

3. The fluid delivery system of claim 2, wherein
the second nominal passageway cross-sectional area is in a range of 2 percent to 50 percent of the first nominal cross-sectional area.

4. The fluid delivery system of claim 1, wherein
the tertiary fluid passageway is configured so that the blind end is defined by a curved surface.

5. The fluid delivery system of claim 4, wherein the curved surface comprises a plurality of linear surfaces arranged to approximate a curved surface.

6. The fluid delivery system of claim 1, wherein
the tertiary fluid passageway has a tertiary nominal passageway cross-sectional area, where the tertiary nominal passageway cross-sectional area is perpendicular to a direction of fluid flow through the tertiary fluid passageway,
the tertiary fluid passageway is configured so that the blind end defines a portion of a chamber having curved surfaces that define a terminal chamber, and
the terminal chamber has a chamber cross-sectional area that is greater than the tertiary nominal passageway cross-sectional area, where the chamber cross-sectional area is parallel to the tertiary nominal passageway cross-sectional area.

7. The fluid delivery system of claim 1, wherein
the secondary fluid passageway has a surface that defines secondary trap openings, and each secondary trap opening is configured to allow passage of particles therethrough under force of gravity.

8. The fluid delivery system of claim 1, wherein
the tertiary fluid passageway has a surface that defines tertiary trap openings, and
each tertiary trap opening is configured to allow passage of particles therethrough under force of gravity.

9. The fluid delivery system of claim 1, wherein
the secondary fluid passageway and the tertiary fluid passageway each have a surface that defines trap openings, and
the trap openings are located within the secondary fluid passageway and tertiary fluid passageway so as to allow passage of particles therethrough under force of gravity.

10. The fluid delivery system of claim 1, wherein
the primary fluid passageway is configured to provide a higher fluid flow velocity at the second location than at the first location.

11. The fluid delivery system of claim 1, wherein
the primary fluid passageway is configured to provide a static fluid pressure gradient across the filter when fluid flows through the primary fluid passageway.

12. The fluid delivery system of claim 1, wherein
the primary fluid passageway has a first passageway cross-sectional area at the first location,
the primary fluid passageway has a second passageway cross-sectional area at the second location, and
the first passageway cross-sectional area is less than the second passageway cross-sectional area.

13. The fluid delivery system of claim 1, wherein
the primary fluid passageway includes a bend and the filter adjoins an outside radius of the bend.

14. The fluid delivery system of claim 13, wherein
the secondary inlet end intersects the primary fluid passageway upstream of the bend with respect to the direction of fluid flow through the primary fluid passageway and the secondary outlet end intersects the primary fluid passageway downstream of the bend with respect to the direction of fluid flow through the primary fluid passageway.

15. The fluid delivery system of claim 14, wherein
the secondary inlet end intersects the primary fluid passageway at the bend and the secondary outlet end intersects the primary fluid passageway downstream of the bend with respect to the direction of fluid flow through the primary fluid passageway.

16. The fluid delivery system of claim 1, wherein
the filter includes a diverter block that is disposed in the filter housing,
the primary fluid passageway is partially defined by a first portion of an inner surface of the housing and a first portion of an outer surface of the diverter block, and
the secondary fluid passageway is partially defined by a second portion of the inner surface of the housing and a second portion of the outer surface of the diverter block.

17. The fluid delivery system of claim 16, wherein
the first portion of the outer surface of the diverter block and the second portion of the outer surface of the diverter block intersect at an edge, and
the edge is configured to divert a portion of fluid flow from the primary fluid passageway to the secondary fluid passageway.

18. The fluid delivery system of claim 17, wherein the edge protrudes into the primary fluid passageway.

19. The fluid delivery system of claim 16, wherein
the first portion of the outer surface of the diverter block and the second portion of the outer surface of the diverter block the diverter block are vertically extending side surfaces of the diverter block, and
the outer surface of the diverter block comprises a third portion that resides in a plane that is perpendicular to the first portion and the second portion.

20. The fluid delivery system of claim 1, wherein
the tertiary fluid passageway divides into an alpha tertiary fluid passageway and a beta tertiary fluid passageway, and
each of the alpha tertiary fluid passageway and the beta tertiary fluid passageway terminates in a blind end.
